(19) United States
(12) Patent Application Publication
(10) Pub. No.: US 2009/0224191 A1
(43) Pub. Date: Sep. 10, 2009

(54) ELECTROMAGNET WATER SUPPLY VALVE

(76) Inventor: Young Sik Nam, (US)

Correspondence Address: Dykema Gossett PLLC;Franklin Square, Third Floor West, 1300 I Street, N.W., Washington, DC, 20005-3353, US

(21) Appl. No.: 12/128,254

(22) Filed: May 28, 2008

(30) Foreign Application Priority Data
Mar. 6, 2008 (KR) 2008-20816

(51) Int. Cl. F16K 31/02

(52) U.S. Cl. 251/129.15

(57) ABSTRACT

Disclosed is an electromagnet water supply valve including a body having at one side an inlet port for receiving water supplied from a water supply pipe and at the other side an outlet port for discharging the water to a user side, in which the body is provided with a valve chest that is divided into an upper portion and a lower portion by a diaphragm, at a middle portion between the inlet port and the outlet port. The electromagnet water supply valve comprises at least one holding ball positioned on each main wall of the inlet and outlet ports of the body, the holding balls penetrating the main walls of the inlet and outlet ports so that the holding balls are positioned at inner and outer sides of the wall; and a plunger placed on an outside of the main wall of the respective inlet and outlet ports and moved along the main wall to push the holding balls towards the main wall of the respective inlet and outlet ports. The holding balls are fastened to the joint hose by a pushing force applied form the plunger.

### BACKGROUND OF THE INVENTION

1. Field of the Invention

The present invention relates to an electromagnet water supply valve for controlling water supply, and more particularly, to an electromagnet water supply valve capable of easily attaching or detaching a target connector, such as a joint hose, to provide a tube passage for guiding water supply.

2. Background of the Related Art

Several valves for controlling the supply of water in washing machines, vending machines, dishwashing machines or the like have been developed and used. A valve of electromagnet type is usually employed as such a valve.

Such a valve includes a body having at one side an inlet port for receiving water supplied from a water supply pipe and at the other side an outlet port for discharging the water to a user side. The body is provided at a middle portion between the inlet port and the outlet port with a valve chest that is divided into an upper portion and a lower portion by a diaphragm. A first valve seat is installed in the upper portion, and is opened and closed by a valve driven by a movable iron core that is operated by an electromagnet, and a second valve seat is installed in the lower portion, and is opened and closed by the diaphragm, thereby controlling the water supply.

Joint hoses for forming a tube passage to supply the water to the outlet port or the inlet port or supply the water to the user side are necessarily installed in the electromagnet valve. In this instance, the joint hoses each connected to the inlet and outlet ports of the electromagnet valve is required for a sufficient clamping force to maintain the watertightness and prevent the joint hoses from being released.

In order to maintain the watertightness and prevent the release of the joint hoses, the joint structure of the joint hose has relatively strong clamping force to the external force and water supply pressure. However, the strong clamping force causes inconvenience in the operation of disconnecting the joint hose, when the valve is repaired or replaced.

Many joint structures have been recently developed to easily connect and disconnect the joint hose. However, since such a joint structure is an additional assembled construction manufactured separately from the body of the valve, there are many drawbacks in that the construction is completed, the assembling operation is not easy, and a manufacturing cost is increased.

### SUMMARY OF THE INVENTION

Accordingly, the present invention is directed to an electromagnet water supply valve that substantially obviates one or more problems due to limitations and disadvantages of the related art.

An object of the present invention is to provide an electromagnet water supply valve capable of being conveniently assembled and thus reducing a manufacturing cost, in which a joint hose is connected to or disconnected from inlet and outlet ports of a body of the electromagnet supply valve by holding balls which come in and out of an inner wall of the respective inlet and outlet ports by a plunger moving along a main wall of the respective inlet and outlet ports.

To achieve the object and other advantages, according to one aspect of the present invention, there is provided an electromagnet water supply valve including a body having at one side an inlet port for receiving water supplied from a water supply pipe and at the other side an outlet port for discharging the water to a user side, in which the body is provided with a valve chest that is divided into an upper portion and a lower portion by a diaphragm, at a middle portion between the inlet port and the outlet port, the electromagnet water supply valve comprising: at least one holding ball positioned on each main wall of the inlet and outlet ports of the body, the holding balls penetrating the main walls of the inlet and outlet ports so that the holding balls are positioned at inner and outer sides of the wall; and a plunger placed on an outside of the main wall of the respective inlet and outlet ports and moved along the main wall to push the holding balls towards the main wall of the respective inlet and outlet ports; in which the holding balls are fastened to the joint hose by a pushing force applied form the plunger.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view illustrating an electromagnet water supply valve according to the present invention;

FIG. 2 is a cross-sectional view illustrating the whole construction of an electromagnet water supply valve according to the present invention;

FIG. 3a is a cross-sectional view illustrating a joint hose joined to an inlet port of an electromagnet water supply valve according to the present invention; and

FIG. 3b is a cross-sectional view illustrating a joint hose joined to an inlet port of an electromagnet water supply valve according to the present invention.

### DETAILED DESCRIPTION OF THE PREFERRED EMBODIMENTS

A preferred embodiment according to the present invention will now be explained with reference to the accompanying drawings.

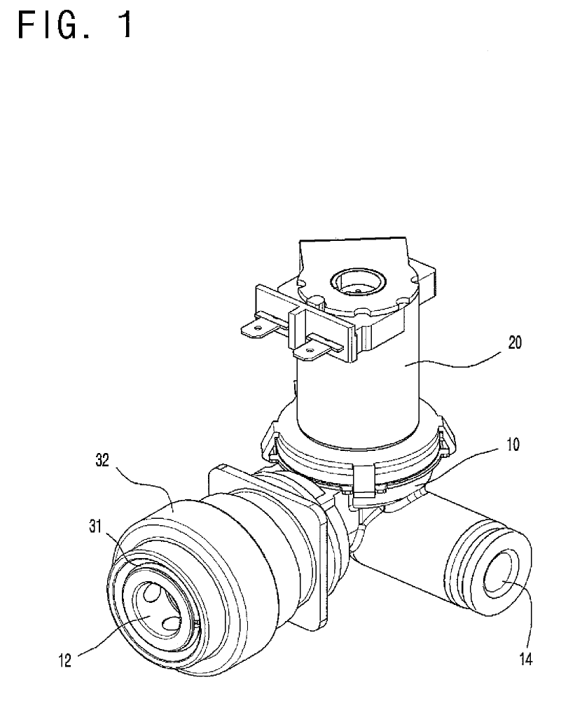

FIG. 1 shows an electromagnet water supply valve according to the present invention.

The electromagnet water supply valve includes a body 10 having at one side an inlet port 12 for receiving water supplied from a water supply pipe and at the other side an outlet port 14 for discharging the water to a user side.

Also, the body 10 is provided with a valve chest 18 that is divided into an upper portion and a lower portion by a diaphragm 16, at a middle portion between the inlet port 12 and the outlet port 14. A first valve seat 26 is installed in the upper portions and is opened and closed by a valve 24 that is driven by a movable iron core 22 operated by an electromagnet 20, and a second valve seat 28 is installed in the lower portion, and is opened and closed by the diaphragm, thereby controlling the water supply.

The above construction is substantially known in the prior art. The electromagnet water supply valve of the present invention is characterized by a connection structure for easily attaching or detaching a target connector, such as a joint hose, to or from the inlet and outlet ports 12 and 14 of the body 10, in which the connector provides a tube passage to supply the water to the inlet or outlet port or supply the water to the user side.

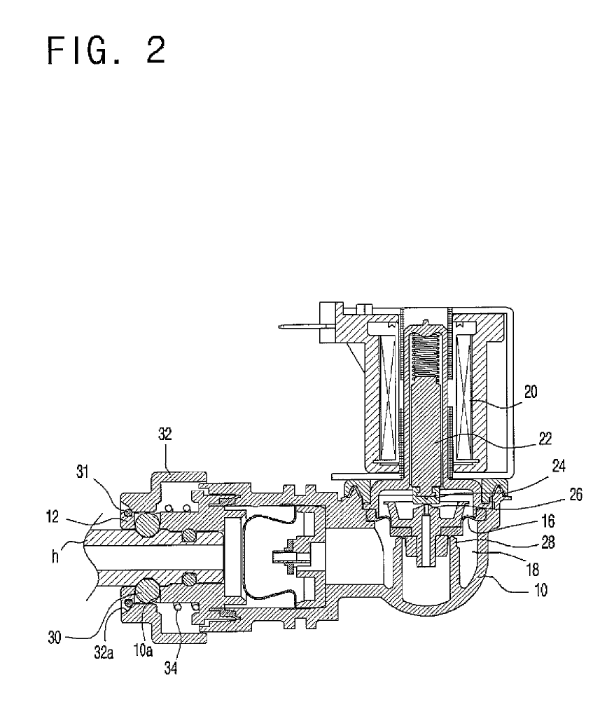

The electromagnet water supply valve of the present invention also includes, as shown in FIG. 2, holding balls 30 positioned on each main wall of the inlet and outlet ports of the body at regular intervals, the holding balls 30 penetrating the walls of the inlet and outlet ports so that the holding balls are positioned at inner and outer sides of the wall. In this instance, the holding balls 30 come in and out of receiving spaces 10a formed on the main walls, without releasing from the receiving spaces. More particularly, the holding balls 30 are moved in the receiving spaces so as to hold or release a joint hose h which will be described hereinafter.

Also, the electromagnet water supply valve of the present invention includes a cap-shaped plunger 32 placed on an outside of the main wall of the respective inlet and outlet ports 12 and 14 and moved along the main wall to apply a clamping force to the joint hose h which pushes the holding balls 30 towards the main wall of the respective inlet and outlet ports 12 and 14. In this instance, the plunger 32 is held by a locking member 31 installed on an outer end portion of the inlet port 12, so that the plunger 32 is not left from the inlet port 12.

The plunger 32 stably fastens the joint hose h by continuously applying a pushing force to the holding balls 30 through a resilient member 34 having a predetermined modulus of elasticity.

The plunger 32 has an inclined surface 32a formed on a front end thereof for releasing the pushing force applied to the holding balls 30.

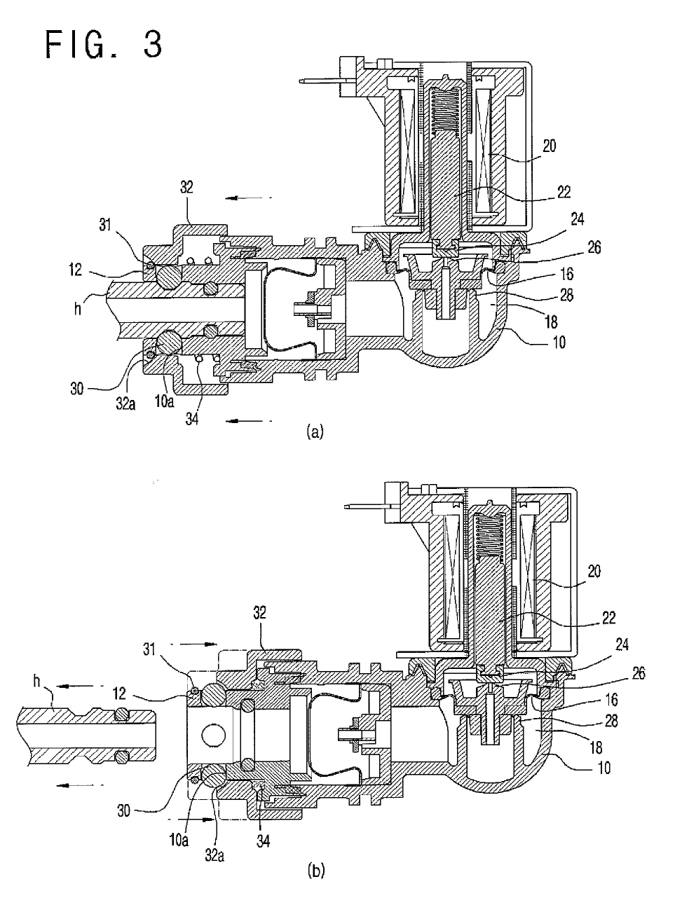

The operation of the electromagnet water supply valve according to the present invention will now be described with reference to FIGS. 3a and 3b.

FIG. 3a shows the joint hose h inserted and joined to the inlet port 12 of the body 10. When the plunger 32 is moved in a left direction by the resilient member 34, as indicated by arrow in FIG. 3a, the holding balls 30 are pushed towards the inlet port 12 by the pushing force to fasten the joint hose h. In this instance, the resilient member 34 has desired resilience that prevents the joint hose h from being easily released from the inlet port 12 by external force (shock), but is removed by the force artificially applied.

FIG. 3b shows the joint hose h released from the inlet port 12 of the body 10. When the plunger 32 is moved in a left direction, as indicated by arrow in FIG. 3b, the holding balls 30 become free of the pushing force of the plunger 32, and thus the joint hose h is released from the inlet port. As a result, the joint hose h can be easily replaced for the maintenance.

With the above construction, the electromagnet water supply valve can be conveniently assembled, and thus a manufacturing cost thereof is reduced, in which the joint hose is connected to or disconnected from the inlet and outlet ports of the body of the electromagnet supply valve by the holding balls which come in and out of the inner wall of the respective inlet and outlet ports by the plunger moving along the main wall of the respective inlet and outlet ports.

The forgoing embodiment is merely exemplary and is not to be construed as limiting the present invention. The present teachings can be readily applied to other types of apparatus. The description of the present invention is intended to be illustrative, and not to limit the scope of the claims. Many alternatives, modifications, and variations will be apparent to those skilled in the art.

What is claimed is:

1. An electromagnet water supply valve including a body having at one side an inlet port for receiving water supplied from a water supply pipe and at the other side an outlet port for discharging the water to a user side, in which the body is provided with a valve chest that is divided into an upper portion and a lower portion by a diaphragm, at a middle portion between the inlet port and the outlet port, the electromagnet water supply valve comprising:
at least one holding ball positioned on each main wall of the inlet and outlet ports of the body, the holding balls penetrating the main walls of the inlet and outlet ports so that the holding balls are positioned at inner and outer sides of the wall; and
a plunger placed on an outside of the main wall of the respective inlet and outlet ports and moved along the main wall to push the holding balls towards the main wall of the respective inlet and outlet ports;
in which the holding balls are fastened to the joint hose by a pushing force applied form the plunger.

2. The electromagnet water supply valve as claimed in claim 1, further comprising a locking member, installed on an outer end portion of the inlet port, for preventing the plunger from being released from the inlet port

3. The electromagnet water supply valve as claimed in claim 1, wherein the plunger is restored by a resilient member.

4. The electromagnet water supply valve as claimed in claim 1, wherein the plunger has at a front end thereof an inclined surface for applying the pushing force to the holding ball.
